(19) United States
(12) Patent Application Publication
(10) Pub. No.: US 2020/0241448 A1
(43) Pub. Date: Jul. 30, 2020

(54) CLEANING STATION SPONGES

(71) Applicant: HP Indigo B.V., Amstelveen (NL)

(72) Inventors: Doron Schlumm, Ness Ziona (IL); Igor Chertov, Ness Ziona (IL); lhab Khahil, Ness Ziona (IL)

(21) Appl. No.: 16/604,380

(22) PCT Filed: Oct. 18, 2017
(86) PCT No.: PCT/EP2017/076606

§ 371 Date: Oct. 10, 2019

(51) Int. Cl. G03G 15/11; B08B 1/00; B08B 3/04

(52) U.S. Cl. CPC G03G 15/11; B08B 3/04; B08B 1/001

(57) ABSTRACT

An example cleaning station for a liquid electrophotographic printer is provided. The cleaning station has a sponge arranged to remove particles from a photo imaging plate of the printer, a fluid supply arranged to apply cleaning fluid to the sponge, a squeezing component arranged to squeeze the sponge in order to remove cleaning fluid and particles from the sponge, and a charging component arranged to electrically charge the squeezing component such that particles are attracted from the sponge to the squeezing component. The squeezing component is electrically isolated within the cleaning station.

### BACKGROUND

Liquid Electro-Photography (LEP) printing devices form images on print media by placing a uniform electrostatic charge on a photoreceptor in the form of a photo imaging plate (PIP) and then selectively discharging the PIP in correspondence with the images. The selective discharging forms a latent electrostatic image on the PIP. Ink comprising charged colorant particles suspended in imaging oil is then developed from a binary ink development (BID) unit on to the latent image formed on the PIP. The image developed on the PIP is offset to an image transfer element comprising a blanket, where it is heated until the solvent evaporates and the resinous colorants melt. This image layer is then transferred to the surface of the print media being supported on a rotating transfer member.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram showing a cross section of a print engine in a liquid electrophotographic printer according to an example;

FIG. 2 is a schematic diagram showing a cross section of a cleaning station of a liquid electrophotographic printer according to an example; and

FIG. 3 is a flow diagram showing a method of operating a cleaning station of a liquid electrophotographic printer according to an example.

### DETAILED DESCRIPTION

In certain LEP printing devices, following transfer of ink from the PIP to the blanket, the PIP passes a photo imaging plate cleaning station (referred to hereinafter as a cleaning station) to prepare the surface of the PIP for recharging and for a new latent image to be formed. The cleaning station may act to cool the PIP to a predetermined temperature by supplying cold fluid, such as imaging oil, to the surface of the PIP. The cleaning station may also clean the PIP of any fused ink debris that has become attached to it after being transferred from the blanket, and any un-fused ink that has not passed to the blanket. The cleaning station can have one or more cleaning sponges, to clean residual ink from the surface of the PIP, and one or more wiper blades to remove imaging oil from the surface of the PIP cleaned by the sponge(s) and to thereby control the amount of imaging oil applied to the PIP.

In certain cases, cleaning fluid, for example in the form of imaging oil, is applied to the sponges and then squeezed out by a separate squeezer to help remove the debris from the sponges. However, if not all of the debris particles are removed, then any remaining particles can, during subsequent rotation of the sponges, scratch a layer of imaging oil that has been deposited on the PIP. Particles may gather under the wiper, causing a change in the thickness of the layer of imaging oil applied to the PIP. Each of these changes in the deposited layer of imaging oil can cause a change in the lateral conductivity of the PIP. This may result in a print quality defect called “vertical scratches” or “vertical lines” on the print.

Certain examples described herein improve a cleaning station of an LEP printer. In examples, a squeezing component is arranged to squeeze a cleaning station sponge, wherein the squeezing component is electrically charged such that particles are attracted from the sponge to the squeezing component. This can increase the efficiency of debris removal from the sponge and help to reduce and/or avoid print quality defects.

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

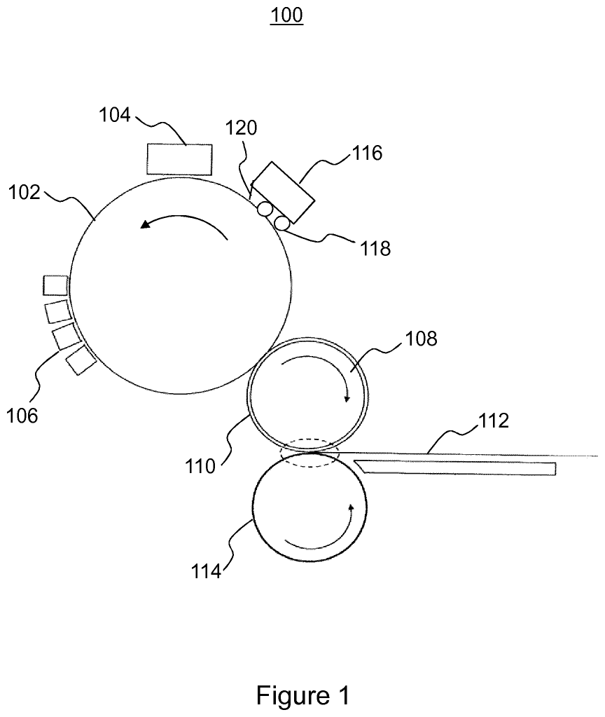

FIG. 1 illustrates example components of a print engine 100 in a liquid electrophotographic printer (LEP). The print engine 100 includes a photo imaging plate 102 (referred to hereinafter as a photo-imaging plate—PIP), a latent image forming unit 104, and one or more binary ink development units 106 (referred to hereinafter as BID units) to develop an ink image on the PIP 102.

In the example print engine 100 of FIG. 1, a desired image is initially formed as a latent electrostatic image on the PIP 102. For example, an image is formed on the PIP 102 by rotating a clean, bare segment of the PIP 102 under the latent image forming unit 104. The latent image forming unit 104 may include a charging device, such as corona wire, charge roller, or other charging device, and a laser imaging portion. A uniform static charge may be deposited on the PIP 102 by the latent image forming unit 104. As the PIP 102 continues to rotate, a charged portion of the PIP 102 passes the laser imaging portion of the latent image forming unit 104. The laser imaging unit may dissipate localized charge in selected portions of the PIP 102 to leave a latent electrostatic charge pattern corresponding to an image to be printed. In some examples, the latent image forming unit 104 applies a negative charge to the surface of the PIP 102. In other examples, the charge may be a positive charge. The laser imaging portion of the latent image forming unit 104 may then locally discharge portions of the PIP 102, resulting in local neutralized regions on the PIP 102.

During a print cycle, at least one of the BID units 106 is engaged with the PIP 102. The engaged BID is to apply liquid ink to the PIP 102. The liquid ink comprises electrically charged ink particles that are attracted to the oppositely charged portions of the PIP 102. The ink particles may be repelled from other areas of the PIP 102. The result is that an image is developed onto the latent electrostatic image provided on the PIP 102.

The print engine 100 also includes an image transfer member 108. In certain cases, the image transfer member 108 comprises a rotatable drum around which is wrapped a blanket 110. In other cases, the image transfer member 108 may comprise a belt or other media transport system. In yet other cases, an image may be directly transferred to a print medium from the PIP 102. Following development of an image on the PIP 102, the PIP 102 continues to rotate and transfers the printing substance, in the form of the image, to the blanket layer 110. In some examples, the image transfer member 108 is electrically charged to facilitate transfer of the image to the blanket 110.

The image transfer member 108 transfers the image from the blanket 110 to a substrate 112 located between the image transfer member 108 and an impression cylinder 114. This process may be repeated, if more than one layer is to be included in a final image to be provided on the substrate 112.

Following transfer of ink from the PIP 102 to the image transfer member 108, the PIP 102 passes a photo-imaging plate cleaning station 116 (referred to hereinafter as a cleaning station) to prepare the surface of the PIP 102 for recharging and for a new latent image to be formed. The cleaning station can comprise one or more cleaning sponges 118, to clean residual ink from the surface of the PIP, and one or more wiper blades 120 to control the amount of imaging oil applied to the PIP. The surface of the PIP may comprise a thin film of conductive material that is referred to as the PIP foil. The thickness of the layer of imaging oil across the surface of the PIP foil affects the lateral conductivity of the PIP foil. Therefore, an even layer of imaging oil across the PIP foil ensures that there is minimal contrast in the lateral conductivity across the PIP foil, resulting in a high quality print.

A print quality defect referred to as “vertical lines” or “vertical scratches”, in which the dot area of the printed image changes within a thin vertical area, can occur in LEP printers owing to the presence of an uneven layer of imaging oil over the PIP foil. This can occur for a number of reasons. For example, imaging oil is applied to the sponges and then squeezed out, using a squeezing component, to help remove particles such as fused ink debris from the sponges; however, in practice not all of the debris particles may be removed from the sponges and remaining particles can scratch the deposited layer of imaging oil on the PIP foil during subsequent rotations of the sponges. The scratched area has the original lateral conductivity of the PIP foil, creating a difference between the lateral conductivity of the scratched area and that of the rest of the PIP foil. Particles that have not been removed from the sponges may also gather under the wiper, affecting the wiper's ability to control the thickness of the imaging oil and resulting in an uneven layer and, consequently, areas of contrasting lateral conductivity. Non-uniformity in printed output quality is commonly referred to as OPS (old photoconductor syndrome). Over time, particles including ink debris can accumulate on the internal components of the cleaning station.

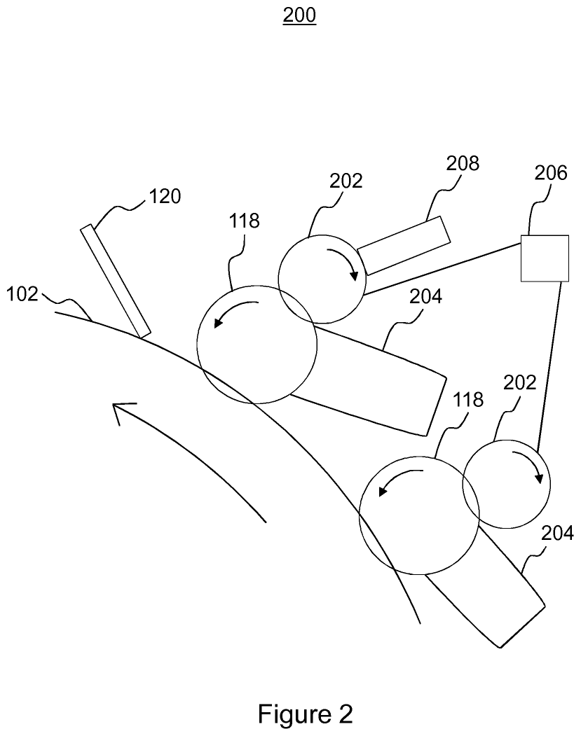

FIG. 2 illustrates the components of a cleaning station 200 according to an example. The cleaning station may be used to help alleviate the print quality defects described above.

The cleaning station 200 comprises one or more sponges 118 that are arranged to remove particles from the PIP 102 of the LEP printer. In the example, the sponges 118 and PIP 102 rotate anti-clockwise, but they could alternatively be arranged to both rotate clockwise. As their surfaces pass one another, the sponge collects particles such as ink debris and dust from the surface of the PIP 102. A fluid supply, in the form of a pump 204, is arranged to apply a cleaning fluid to each of the sponges 118. The cleaning fluid is non-conductive and may be imaging oil. One or more squeezing components 202, such as rotatable squeezers, are arranged to squeeze each of the sponges 118 in order to remove the cleaning fluid and particles from the sponges 118. Many of the particles can then be flushed from the squeezing components 202 into a cleaning station bath (not shown). The particles are subsequently filtered from the cleaning fluid. In an example in which the cleaning fluid is imaging oil, the filtered imaging oil can be recycled for application to the PIP 102.

In addition to wetting and squeezing the one or more sponges 118, the cleaning station 200 has a charging component 206 arranged to electrically charge the squeezing component 202 such that particles are attracted from each sponge 118 to its respective squeezing component 202. The particles present in an LEP printer, including fused ink particles, may have electrical properties and may, therefore, react to an induced electric field. In an example, a positive voltage, for example +1000V, can be applied to one or more of the squeezing components 202 in order to attracts particles from the pores of the respective sponge(s) 118 (to which no electric charge is applied) to the respective squeezing component(s) 202. This helps to remove particles from the pores of the sponges 118. In particular, particles that are not removed by wetting and squeezing the sponges 118, such as particles that are trapped in inner pores of the sponges 118, can be removed. Therefore, the sponges 118 are cleaned more efficiently and the chance of scratching the imaging oil layer, and hence the print, is reduced.

In order to induce an electric field between the sponges 118 and the squeezing components 202 as described above, the squeezing component 202 is electrically isolated within the cleaning station 200. For example, non-conductive bearings may be connected to each squeezing component 202 in order to isolate it from the remaining components of the cleaning station 200. The bearings may be polymer ball bearings or ceramic ball bearings. Metal ball bearings can be used, in which case they are arranged to be electrically isolated from the remaining components of the cleaning station 200.

The electric field can subsequently turned off or reduced in order to release the particles from the squeezing components 202. The cleaning fluid circulating through the cleaning station 200 can then flush the particles towards the cleaning station bath. The squeezing components 202 may be coated in an anti-sludge coating, such as a Silicone-PolyUrethane (“SiPU”) coating, to increase the ease with which the particles are removed by the cleaning fluid. The charging component 206 may be a pulse generator (and an associated power supply), which can apply an alternating current (AC) square signal to the squeezing components 202, for example to turn the electric field off and on after predetermined periods of time, such as every few seconds. In another example, a DC signal can be applied to the squeezing components to attract particles from the sponges 118 to the squeezing components 202. Alternatively, the particles can be removed from the squeezing components 202 by flushing the squeezing components 202 with cleaning fluid, without reducing, turning off or changing the direction of the induced electric field.

One or more additional cleaning components can be provided to remove particles from the electrically charged squeezing components 202; a single cleaning component 208 is shown for illustrative purposes in FIG. 2, but a cleaning component 208 for each of the squeezing components 202 may be provided. Such a cleaning component 208 can help to ensure that the particles are not returned to the sponges 118 as the squeezing components 202 rotate or the electric field strength is changed. The cleaning component 208 may be a wiper or a suction component. Alternatively, the cleaning component may be a separately chargeable member, such that an electric field is induced between the squeezing component 202 and the cleaning component 208; in an example where the squeezing component 202 is positively charged to attract particles form the sponge, a higher positive charge can be applied to the cleaning component 208 in order to attract the particles to the cleaning component 208.

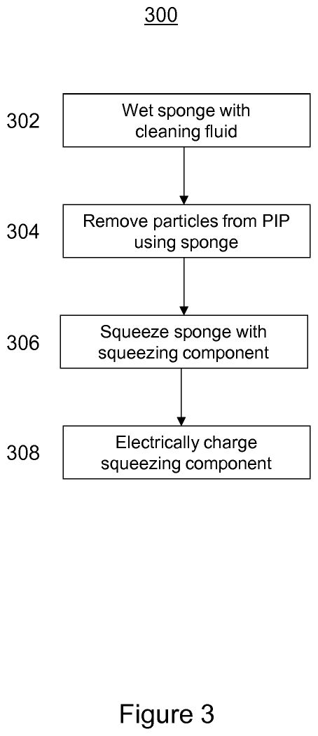

FIG. 3 is a flow diagram showing a method 300 of operating a cleaning station, such as the cleaning station 200 described with reference to FIG. 2, according to an example.

At block 302, each sponge 118 is wetted with cleaning fluid; this may be performed using a pump 204 that applies imaging oil, as described above with reference to FIG. 2.

At block 304, particles are removed from the PIP 102 of the printer using the sponge 118. The sponge 118 may rotate anti-clockwise against the PIP surface as the PIP rotates anti-clockwise.

At block 306, each squeezing component 202 is used to squeeze its respective sponge 118, to remove cleaning fluid and particles from the sponge 118.

At block 308, the electrically isolated squeezing component 202 is electrically charged such that particles are attracted from the sponge to the squeezing component. The electric charge applied to the squeezing component 202 may then be reduced so that the particles are repelled from the squeezing component 202. For example, an AC square signal may be applied to the squeezing component 202 using a pulse generator. The squeezing component 202 itself can then be wetted with cleaning fluid to remove particles from the squeezing component; alternatively or in addition, an electric field may be applied to the squeezing component to remove particles from the squeezing component.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A cleaning station for a liquid electrophotographic printer comprising:
a sponge arranged to remove particles from a photo imaging plate of the printer;
a fluid supply arranged to apply cleaning fluid to the sponge;
a squeezing component arranged to squeeze the sponge in order to remove cleaning fluid and particles from the sponge, wherein the squeezing component is electrically isolated within the cleaning station; and
a charging component arranged to electrically charge the squeezing component such that particles are attracted from the sponge to the squeezing component.

2. The cleaning station of claim 1, wherein the charging component is arranged to reduce the electric charge applied to the squeezing component such that the particles are released from the squeezing component.

3. The cleaning station of claim 2, wherein the charging component is a pulse generator arranged to apply an AC square signal to the squeezing component.

4. The cleaning station of claim 1, comprising non-conductive bearings connected to the squeezing component, in order to electrically isolate the squeezing component within the cleaning station.

5. The cleaning station of claim 1, comprising a cleaning component arranged to remove particles from the squeezing component.

6. A liquid electrophotographic printer comprising a cleaning station, the cleaning station comprising:
a sponge arranged to remove particles from a photo imaging plate of the printer;
a fluid supply arranged to apply cleaning fluid to the sponge;
a squeezing component arranged to squeeze the sponge in order to remove cleaning fluid and particles from the sponge, wherein the squeezing component is electrically isolated within the cleaning station; and
a charging component arranged to electrically charge the squeezing component such that particles are attracted from the sponge to the squeezing component.

7. The liquid electrophotographic printer of claim 6, wherein the charging component is arranged to reduce the electric charge applied to the squeezing component such that the particles are released from the squeezing component.

8. The liquid electrophotographic printer of claim 7, wherein the charging component is a pulse generator arranged to apply an AC square signal to the squeezing component.

9. The liquid electrophotographic printer of claim 6, comprising non-conductive bearings connected to the squeezing component, in order to electrically isolate the squeezing component within the cleaning station.

10. The liquid electrophotographic printer of claim 6, comprising a cleaning component arranged to remove particles from the squeezing component.

11. A method of operating a cleaning station of a liquid electrophotographic printer, the method comprising:
wetting a sponge with cleaning fluid;
removing particles from a photo imaging plate of the printer using the sponge;
squeezing the sponge using a squeezing component to remove cleaning fluid and particles from the sponge, wherein the squeezing component is electrically isolated within the cleaning station; and
electrically charging the squeezing component such that particles are attracted from the sponge to the squeezing component.

12. The method of claim 11, comprising reducing the electric charge applied to the squeezing component such that the particles are released from the squeezing component.

13. The method of claim 12, comprising applying an AC square signal to the squeezing component using a pulse generator.

14. The method of claim 11, comprising wetting the squeezing component with cleaning fluid to remove particles from the squeezing component.

15. The method of claim 11, comprising applying an electric field to the squeezing component to remove particles from the squeezing component.
